(19) United States
(12) Patent Application Publication
(10) Pub. No.: US 2018/0138632 A1
(43) Pub. Date: May 17, 2018

(54) A MECHANICAL PROTECTIVE RING FOR A FEMALE CONNECTOR OF THE JACK TYPE FOR A 4.3-10 COAXIAL CONNECTION SYSTEM

(71) Applicant: RADIALL, Aubervilliers (FR)

(72) Inventors: Shan QIN, Shanghai (CN); Chen SU, Shanghai (CN)

(73) Assignee: RADIALL, Aubervilliers (FR)

(21) Appl. No.: 15/320,641

(22) PCT Filed: Nov. 11, 2016
(86) PCT No.: PCT/CN2016/105519

§ 371 Date: Dec. 20, 2016

(51) Int. Cl. H01R 13/623; H01R 13/434; H01R 13/52; H01R 24/38

(52) U.S. Cl. CPC H01R 13/623; H01R 24/38; H01R 13/5202; H01R 13/434

(57) ABSTRACT

A mechanical protective ring is made of a dielectric material, with an external diameter intended to cooperate with the inner diameter of a ground contact of a 4.3-10 female connector, and with an inner diameter adapted such that in case of a mismating of a ground contact of a 4.1-9.5 plug connector into the ring, the front face of ring comes into abutment with the ground contact of a 4.1-9.5 plug connector.

### TECHNICAL FIELD

The present invention relates to a female connector, of the jack type, for a 4.3-10 coaxial connection system, intended in particular to transmit radio frequency RF signals.

The applications particularly targeted by the invention are the connection of telecommunication equipment such as base transceiver stations BTS, RRU/RRH (remote radio unit/remote radio head) units and distributed antenna system for the wireless communications market.

The invention more particularly aims to propose a solution in order to avoid a destructive connection between a male connector of a connection system, designed under the series 4.1-9.5 standard designation, hereinafter a 4.1-9.5 male connector, and a female connector of a connection system, designed under the series 4.3-10 standard designation, hereinafter a 4.3-10 female connector.

### PRIOR ART

The market and the prior art already feature power connectors of coaxial type for low passive intermodulation and dedicated to the telecommunications sector for cellular radio telephony infrastructures.

The trend in this market is to minimize the generation of passive intermodulation products. This is because, although the passive components, such as coaxial connectors and RF loads, were considered to be linear, it has been found that in reality these components were susceptible to behave as intermodulation generators, that is to say non-linear generators of unwanted modulation of the RF signals, which can lead to a distortion of the signals output from said components.

Thus, the connectors manufacturers, and in particular the applicant, have already developed, from proven coaxial connectors, connectors with high RF performance levels, notably with low intermodulation levels, such as those marketed under the series 4.1-9.5 and 4.3-10 designations which are IEC standards.

More particularly, the RF coaxial connection system of the 4.1-9.5 type is a standard under the reference IEC 60169-11 Ed. 1.0 (1977), which defines an inner diameter of the outer conductor (peripheral contact) of a 9.5 mm (0.374 inch) value with a characteristic impedance of 50 ohms and with a screw coupling as a locking device for mechanical locking the plug to the jack when they are in mutual connection configuration.

The RF coaxial connection system of the 4.3-10 type is a standard project under the reference IEC 61169-54:2016, which defines an inner diameter of the outer conductor (peripheral contact) of a 10 mm (0.394 inch) value with a nominal characteristic impedance of 50 ohms.

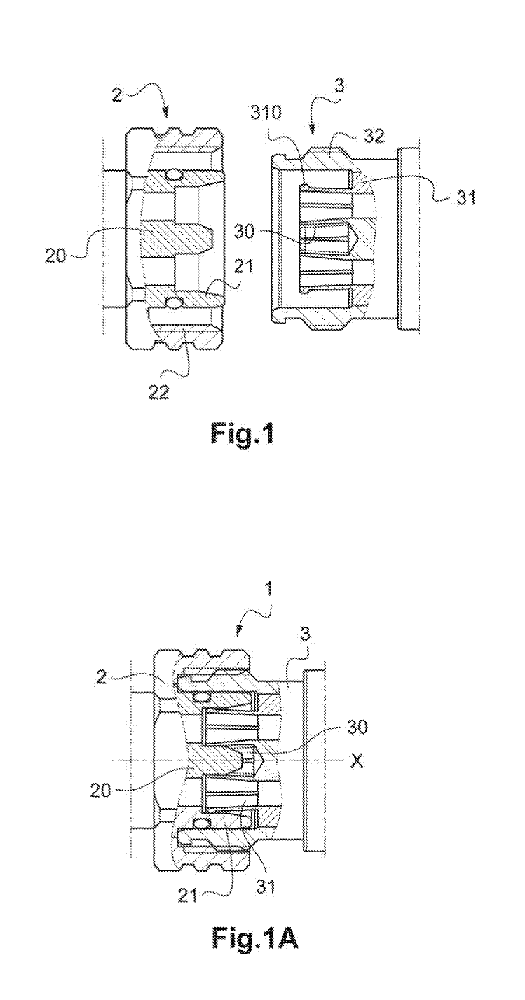

FIGS. 1 and 1A show, in longitudinal cross section, a coaxial power connection system 1, which has been marketed since several years under the series 4.3-10 designation, as specified in the standard IEC 61169-54:2016.

The jack 3 comprises a central contact 30 and a peripheral contact 31 arranged at the periphery of the central contact, forming a ground contact.

The plug 2 itself comprises a central contact 20 and a peripheral contact 21 arranged at the periphery of the central contact, forming a ground contact. For better contact between the peripheral contact 21 of the plug 2 and the slotted peripheral contact 31 of the jack 3, the slotted peripheral contact 31 is horn shaped as a petal 310 and can withstand the elastic deformation.

In order to mechanically lock the mutual connection between plug and jack, a locking nut 22 is provided, to be screwed on the threads 32, around both the plug and the jack.

In this connection system 1, the electrical and mechanical functions can be separated, and electrical performances shall not be depended on the coupling torque, such that the connection has low intermodulation even mated with a small torque applied, typically on the order of 1 N.m. This allows the operator to mate the connection system conveniently.

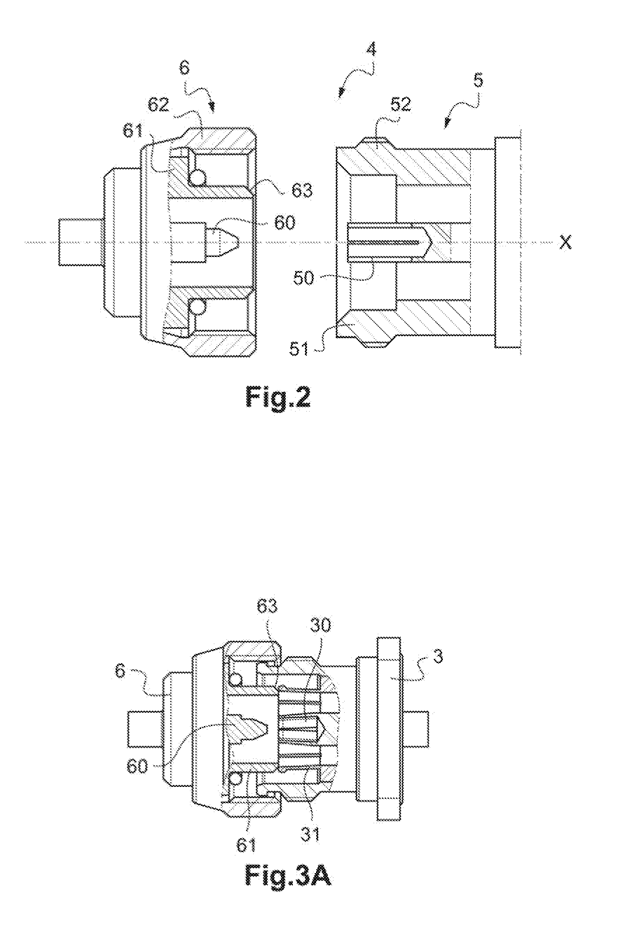

FIG. 2 shows, in longitudinal cross section, a coaxial power connection system 4, which has been marketed since more than 30 years under the series 4.1-9.5 designation as specified in the standard IEC 60169-11.

The jack 5 comprises a central contact 50 and a peripheral contact 51 arranged at the periphery of the central contact, forming a ground contact.

The plug 6 itself comprises a central contact 60 and a peripheral contact 61 arranged at the periphery of the central contact, forming a ground contact.

In order to mechanically lock the mutual connection between plug and jack, a locking nut 62 is provided, to be screwed on the threads 52, around both the plug and the jack.

In this connection system 4, a low intermodulation can be achieved only if a high fastening torque is applied, typically on the order of 10 N.m.

A 4.1-9.5 connection system 4 and a 4.3-10 connection system 1 are dedicated to the same applications, notably in the field of telecommunications as mentioned above and may be found simultaneously on the same equipment

The threads 22, 32 and 52, 62 to achieve the locking in both 4.1-9.5 and 4.3-10 connection systems 1; 4 are identical, of the M20×1 type.

Moreover, the external size of the connectors 2,3 is the same than for connectors 5,6, and the outer shape of the plug 2 of the 4.3-10 system 1 is similar than the plug 6 of the 4.1-9.5 system 4.

Due to these identical sizes and similar shapes, an operator in charge of making the connection can easily confuse these two connections systems 1 and 4, when manipulating them.

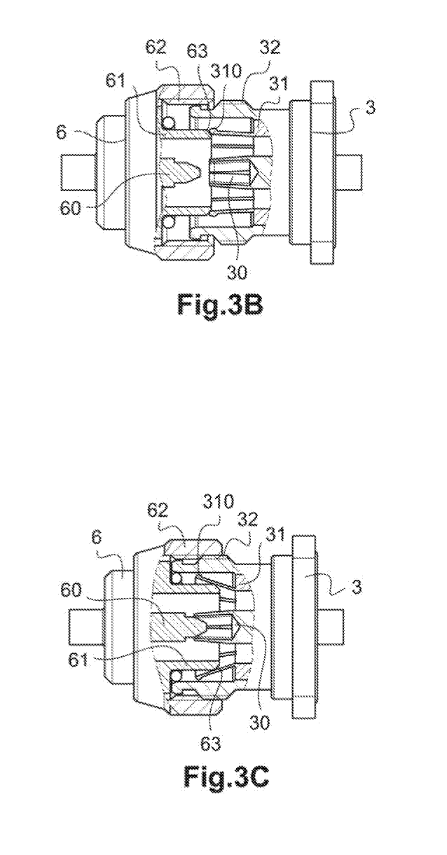

If such an error on the types of connection system arrives, damages occur on the connectors, as shown on FIGS. 3A, 3B and 3C.

When an operator accidentally makes a mismating between a 4.1-9.5 plug 6 and a 4.3-10 jack 3, the peripheral contact 61 with has a chamfer 63 at the front end of the interface of the plug 6 can easily go into the slotted peripheral contact 31, after tighten the coupling nut 62 with thread 32 even manually. Then, it can occur a plastic deformation of the petals 310 of the peripheral contact 31, as shown in FIG. 3C.

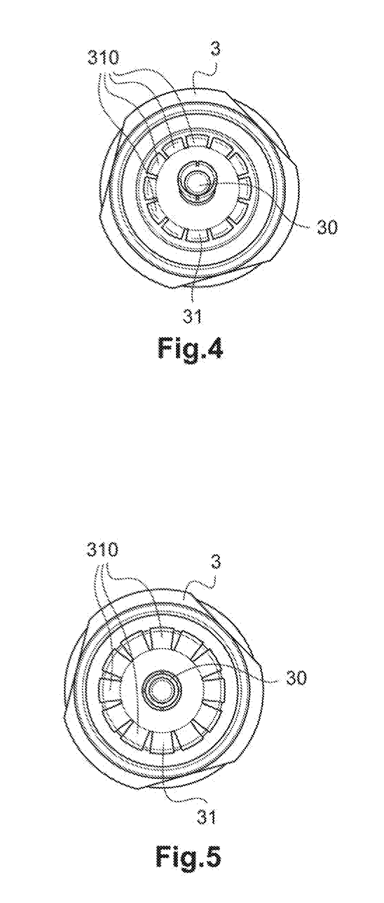

FIG. 4 shows a normal state of the peripheral contact 31 of the jack 3 while FIG. 5 shows a damaged jack 3 in which the peripheral contact 31 has been undesired plastically deformed with its petals 310 completely apart from their normal resting position,

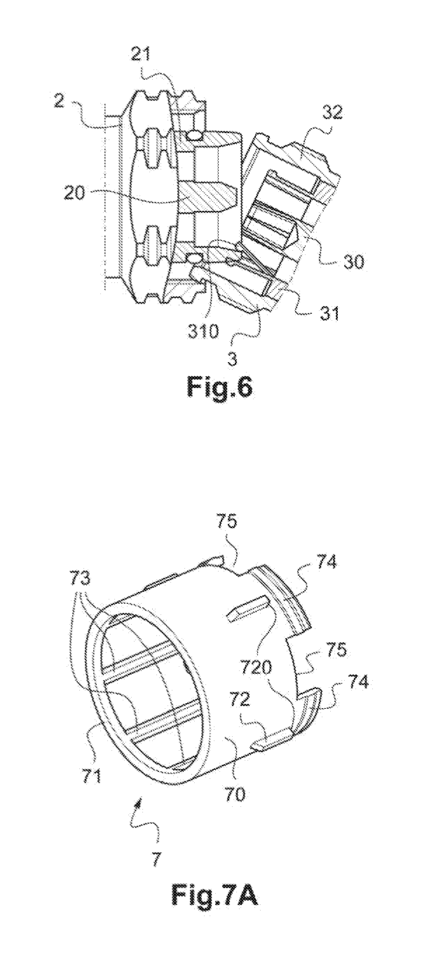

Additionally, it is possible that during a connexion between a 4.3-10 plug and a 4.3-10 jack, the 4.3-10 plug 2 has a big tilting angle of 15˜25°, due to the short guidance during the connexion operation, such that the petals 310 of the slotted peripheral contact 31 of the 4.3-10 jack 3 may have a big deformation as shown on FIG. 6.

Because no mechanical protection is provided, as described above it is possible to permanently deform in a plastic state, the slotted peripheral contact 31, if the material is not enough elastic in order to resist to additional lateral forces, for example, which can he brought from the gravity of the mass of the cable assembly which is linked to the jack 3.

In the same way, such an important deformation may occur during an unmating operation as well. Such deformations would drastically reduce the intermodulation performance of the connexion.

There is therefore a need to further improve the RF coaxial connection systems of the 4.3-10 type, notably in order to prevent any mismating between a 4.1-9.5 male connector and a 4.3-10 female connector.

Additionally, there is a need to increase the robustness of a 4.3-10 connexion, and to achieve a mechanical protection for the slotted peripheral contact of a 4.3-10 female connector during the mating and unmating operations.

The invention aims to address all or some of this (these) need(s).

### Explanation of the Invention

The subject of the invention is thus a mechanical protective ring, made of a dielectric material, with an external diameter intended to cooperate with the inner diameter of a ground contact of a 4.3-10 female connector, and with an inner diameter adapted such that in case of a mismating of a ground contact of a 4.1-9.5 plug connector into said ring, the front face of ring comes into abutment with said ground contact of a 4.1-9.5 plug connector.

Thus, the invention mainly consists in the use of a supplemental piece, inserted between the center contact and the outer contact which prevents any introduction of a male connector which is not dedicated.

In other words, the protective ring according to the invention avoids the undesired deformation (damage) of the elastic slotted peripheral contact.

A female connector with a protective ring according to the invention meets the requirement of a jack under the series 4.3-10 designation.

A 4.3-10 female connector according to the invention has the following advantages:
it prevents any accidental mating between a 4.3-10 female connector and a 4.1-9.5 plug connector, and therefore it avoids damages which would occur in case of mismating of a 4.1-9.5 male connector;
it mechanically protects the slotted peripheral contact during mating and unmating operations of series 4.3-10 connector systems, thanks to its rigid material and its stiffening ribs, avoiding degradation of the intermodulation levels due to any undesired deformation of the petals of the peripheral contact
the protective ring according to the invention can be directly inserted and maintained in an existing 4.3-10 female connector (jack), with no need to change the structure and/or the dimension of said connector;
the protective ring according to the invention has a very slight influence on the RF electrical performances, especially no influence on the intermodulation performances, when used in a 4.3-10 jack, a 4.3-10 female connector (jack) mated with a 4.3-10 plug connector;
the protective ring according to the invention can be manufactured in a molded plastic material, which minimizes the cost added to an existing 4.3-10 connection system.

According to an advantageous embodiment, the ring is made of a cylindrical piece with longitudinal stiffening ribs, spaced one from the others, extending parallel to the axis of the cylinder.

Preferably, the stiffening ribs extend along the whole length of the ring.

Preferably, the ring comprises peripheral cutouts which are located at the rear end of the ring facing the bottom of the peripheral contact.

The invention concerns also, under another aspect, a female connector of the 4.3-10 jack type for a coaxial connection system, intended to transmit radio frequency RF signals, of longitudinal axis X, the female connector comprising:
a central contact,
a peripheral slotted contact, arranged on the periphery of the central contact, forming a ground contact,
a mechanical protective ring such as described above, which is arranged between the central contact and the slotted ground contact.

According to an advantageous variant, the mechanical protective ring has at least one protrusion on its periphery which is inserted in a slot of the peripheral slotted contact while being in abutment with the bottom of said slot, said ring having at least one surface defining an exterior diameter in interference fit with a diameter of an internal surface of the peripheral contact.

Preferably, the front end of the ring is aligned in the plane (P) defined by the front end of the elastic portions of the peripheral contact.

At last, the invention concerns a coaxial connection system, marketed under the series 4.3-10 standard designation, comprising a male connector of the type plug and a female connector of the jack type such as described above.

### DETAILED DESCRIPTION

Other advantages and features of the invention will become more apparent on reading the detailed description of exemplary implementations of the invention, given as illustrative and non-limiting examples with reference to the following figures in which:

FIGS. 1 and 1A are longitudinal cross-sectional views of a coaxial connection system under series 4.3-10 according to the prior art, the plug and the jack being respectively spaced one from the other in a ready position to be connected, and in mutual connection and locked configuration;

FIG. 2 is a longitudinal cross-sectional view of a coaxial connection system according to the prior art, marketed under the series 4.1-9.5, the plug and the jack being spaced one from the other, m a ready position to be connected;

FIG. 3A, 3B and 3C are a longitudinal cross section of a 4.1-9.5 plug and a 4.3-10 jack according to the prior art, during a mismating operation, respectively when the peripheral contact of the 4.1-9.5 plug begins to be in a physical contact with the peripheral contact of the 4.3-10 jack and when the undesired insertion is made;

FIG. 4 is a reproduction of a photography of a 4.3-10 jack according to the prior art, after a correct mating and unmating with a complementary 4.3-10 plug;

FIG. 5 is a reproduction of a photography of a 4.3-10 jack according to the prior art, after a mismating with a 4.1-9.5 plug according to the prior art, FIG. 5 showing the undesired permanent deformation of a peripheral contact of the 4.3-10 jack;

FIG. 6 is a longitudinal cross-sectional view of a 4.3-10 plug and a 4.3-10 jack according to the prior art, during a connexion operation in which a tilting angle is involved;

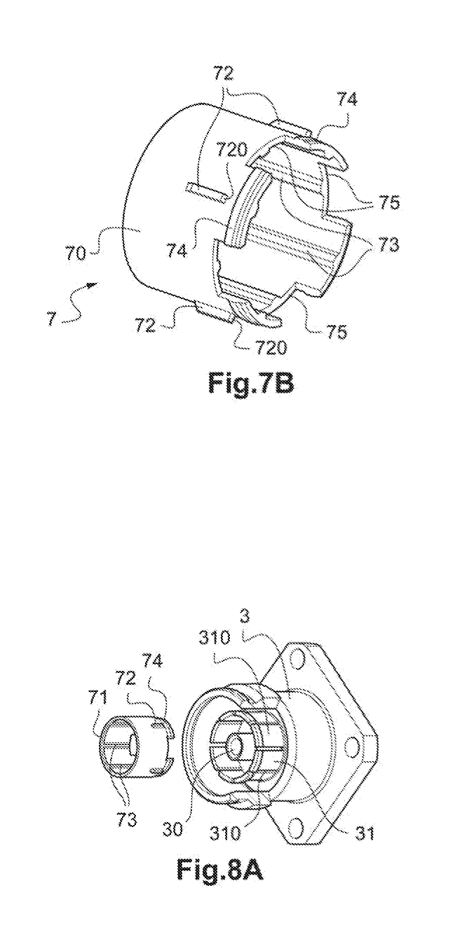

FIGS. 7A and 7B are perspective views of a mechanical protective ring according the invention;

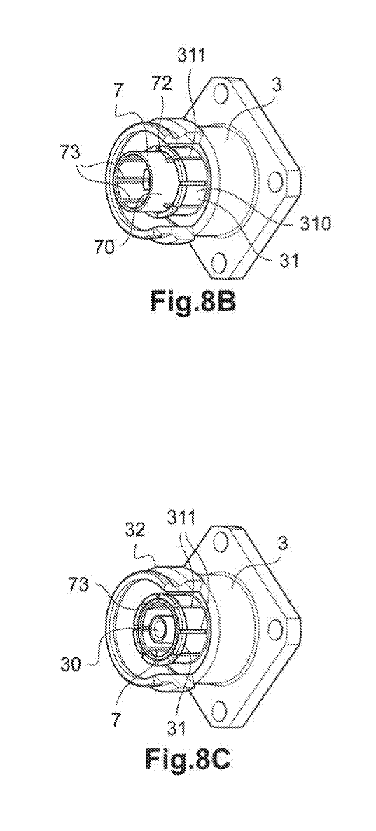

FIGS. 8A to 8C are perspective views showing the different steps of the insertion and retention of the protective ring according to FIGS. 7A and 7B a 4.3-10 jack;

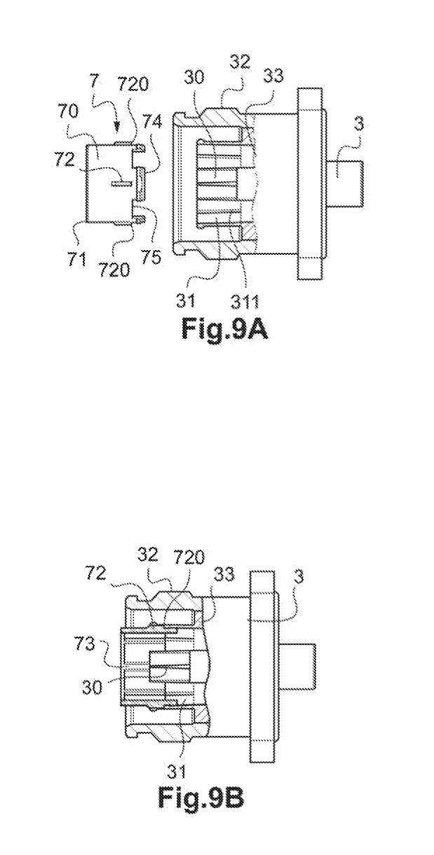

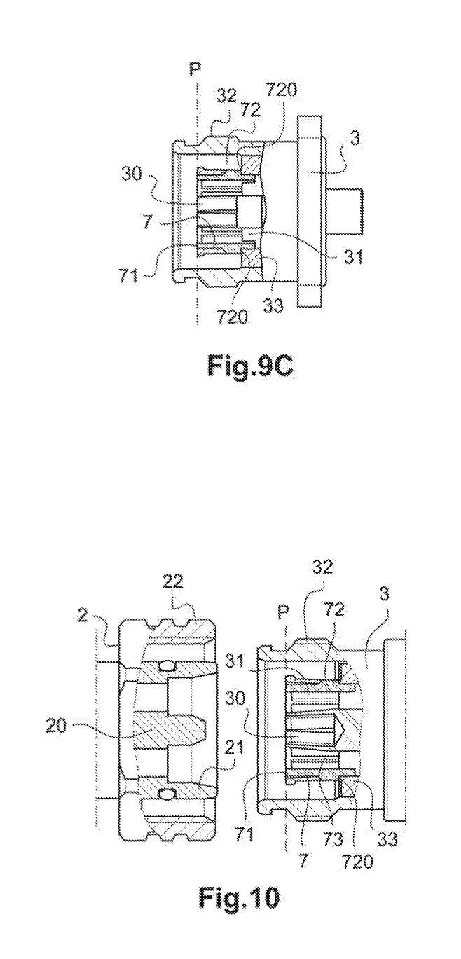

FIGS. 9A to 9C are longitudinal cross-sectional views showing the same steps that those shown an FIGS. 8A to 8C;

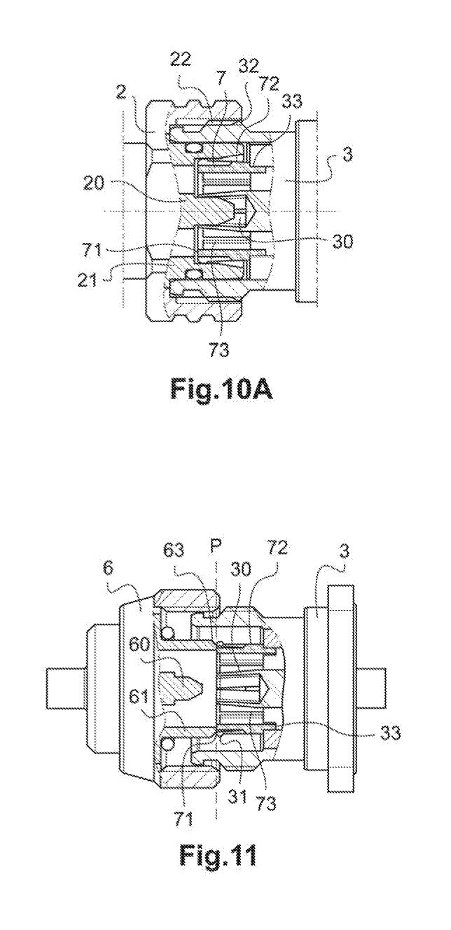

FIGS. 10 and 10A are longitudinal cross-sectional views of a coaxial connection system under series 4.3-10 according to the invention, the plug and the jack with the protective ring being respectively spaced one from the other in a ready position to be connected, and in mutual connection and locking configuration;

FIG. 11 is a longitudinal cross-sectional view showing the impossibility to connect a 4.1-9.5 plug in a 4.3-10 jack according to the invention.

FIGS. 1 to 6 relate to different examples of coaxial connection systems according to the prior art.

These FIGS. 1 to 6 have already been commented on in the preamble and will not therefore be commented on further herein below.

In the interests of clarity, the same references designating the same elements of a connection system according to the prior art and of a 4.3-10 connection system according to the invention are used for all the FIGS. 1 to 6.

According to the invention, it is provided a protective ring 7 intended to be inserted and mechanically retained in a 4.3-10 jack

As shown an FIGS. 7A and 7B, the ring, 7 is made of a unique piece which is mainly a thin-walled cylinder 70 with a continuous circular front end 71.

The piece 7 is made of a molded plastic material, such as POM or PBT, which has a relatively high mechanical rigidity compare to PTFE, and a low dielectric constant. Moreover, molded plastic material minimizes the cost added to an existing 4.3-10 connection system.

The ring comprises several protrusions 72 distributed regularly on the cylindrical surface 70. The outer diameter of the cylindrical surface 70 of the ring 7 is slightly smaller than the diameter of internal surface of the slotted peripheral contact 31 under working condition (when a 4.3-10 standard plug mated with a 4.3-10 jack), such that there is no supplemental mechanical constraint when a 4.3-10 standard plug 2 is mated with a 4.3-10 jack 3 with a ring 7 according to the invention.

When there are additional lateral forces during an unmating operation, the ring 7 protects the slotted peripheral contact 31 by the cylindrical surface 70, due to its great rigidity material and stiffening ribs, in order to avoid any deformation of the petals 310 of the peripheral contact 31.

As explained hereafter, each protrusion 72 has a width which is slightly smaller than the width of a slot 311 which separates two adjacent petals 310 of a peripheral contact 31 of a female connector (jack) 3.

Inside the ring 7, several stiffening ribs 73 are spaced one from the others, extending parallel to the axis of the cylinder, along the whole length of the ring 7. The thickness of the stiffening ribs is comprised between 0.1 and 0.5 mm.

It must be understood that these dimensions are optimized with a plain material and that they are not restrictive. The main feature to he respected is the mechanical rigidity of the piece according to the invention. A foam or honeycomb structures for example may be used as well with various associated thickness. And the design of the ring has to be optimized with the global dielectric constant and the requested RF performances.

At the rear end of the ring 7, there are some surfaces 74, two adjacent surfaces 74 being separated by a cutout 75. The diameter defined by the surfaces 74 is the biggest diameter of the ring 7, except for the protrusions 72.

The mounting of the protective ring 7 in a 4.3-10 known female connector is now described by reference to FIGS. 8A to 8C and FIGS. 9A to 9C.

Firstly, the ring 7 is brought in front of and centered with the 4.3-10 jack 3 with the rear end, i.e. the surfaces 74 and the cutouts 75 facing the space between the center contact 30 and the peripheral contact 31.

The protrusions 72 are aligned individually to the direction of a slot 311 of the slotted peripheral contact 31, such that each protrusion 72 can be inserted easily into a corresponding slot 311 (FIGS. 8A and 9A).

Then, the ring 7 is pushed into the 4.3-10 jack 3, being guided by the sliding of the protrusions 72 into the slots 311 (FIGS. 8B and 9B).

The ring 7 is pushed until that its rear end, i.e. the ends 720 of the protrusions 72 are in abutment against the bottom 33 of the slots 311 of the slotted peripheral contact 31 (FIGS. 8C and 9C).

While attaining this abutment, it occurs an interference fit between the surfaces 74 of the ring 7 and the internal surface of outer contact 31. This interference fit allows the mechanical retention of the ring 7 into the 4.3-10 jack 3. Typically, the tolerance of the interference fit between the ring 7 and the peripheral contact is at least 0.02 mm.

In the mounted configuration, the front end 71 of the ring 7 is aligned with the front end of the petals 310 of the peripheral contact 31 in the same plane P. Of course, due to the tolerances, it has to understood that the expression “same plane” has to understood as in the same plane, to within the tolerances.

FIGS. 10 and 10A show the connection between an existing 4.3-10 plug 2 and a 4.3-10 jack including a protective ring 7 according to the invention.

The cutouts 75, the thin-walled structure 70 and a low dielectric constant of material allows the ring 7 to minimize its influence on the RF electrical performance of the connection system 1. The typical thickness of the cylindrical piece of the ring 7 is between 0.3 to 0.8 mm. Due to very slight influence on the RF electrical performances and no influence for intermodulation, the protective ring can be directly inserted and maintained in an existing 4.3-10 female connector with no change for the structure and dimensions.

There may be a possible tilting angle between 4.3-10 plug and 4.3-10 jack due to the short guidance because there are additional lateral forces during an unmating operation. The ring 7 protects the slotted peripheral contact 31 by the cylindrical surface 70, due to its great rigid material and with internal stiffening ribs of ring, in order to avoid the worse intermodulation level or failure from any undesired deformation of the petals 310 of the peripheral contact 31.

If an operator would mistakenly try to mate a 4.1-9.5 plug 6 with a 4.3-10 jack 3 including a protective ring 7 according to the invention, then this latter will avoid it by creating a physical barrier.

This situation is shown on FIG. 11: the front end 63 under a chamfer shape of a 4.1-9.5 plug 6 is in abutment with the front end 71 of the ring 7 retained into the 4.3-10 jack 3. Due to the intrinsic rigidity of the material of the cylinder 70 and to the stiffening ribs 73 which increase the rigidity, the 4.1-9.5 plug 6 cannot deform the petals 310 of the outer contact 31 to penetrate into.

The ring 7 thus avoids the risk of accidental damages of the peripheral contact 31 due to an undesired intrusion of a 4.1-9.5 plug 6 by mismating.

Other variants and enhancements can be provided without in any way departing from the framework of the invention.

The expression “comprising a” should be understood to be synonymous with “comprising at least one”, unless otherwise specified.

1. (canceled)

2. A female connector according to claim 5, wherein the mechanical protective ring is a cylindrical piece with longitudinal stiffening ribs, spaced one from each other, extending parallel to the axis of the cylinder.

3. A female connector according to claim 2, wherein the stiffening ribs extend along the whole length of the mechanical protective ring.

4. A female connector according to claim 5, wherein the mechanical protective ring comprises peripheral cutouts which are located at the rear end of the mechanical protective ring facing the bottom of the peripheral slotted contact.

5. A female connector of the 4.3-10 jack type for a coaxial connection system, intended to transmit radio frequency RF signals, of longitudinal axis X, the female connector comprising:
a central contact,
a peripheral slotted contact, arranged on a periphery of the central contact, forming a ground contact, the peripheral slotted contact having elastic portions adapted to withstand elastic deformation, and
a mechanical protective ring made of a a dielectric material, with an external diameter intended to cooperate with an inner diameter of a ground contact of a 4.3-10 female connector, with a length, with a front end, with a rear end facing a bottom of the peripheral slotted contact, and with an inner diameter adapted such that in case of a mismating of a ground contact of a 4.1-9.5 plug connector into said ring, the front end of said ring comes into abutment with said ground contact of a 4.1-9.5 plug connector, said mechanical ring being arranged between the central contact and the ground contact,
the mechanical protective ring having at least one protrusion on its periphery which is inserted in a slot of the peripheral slotted contact while being in abutment with the bottom of said slot, said ring having at least one surface defining an exterior diameter in interference fit with a diameter of an internal surface of the peripheral slotted contact.

6. (canceled)

7. A female connector according to claim 5, wherein the front end of the ring is aligned in a plane defined by a front end of the elastic portions of the peripheral slotted contact.

8. A coaxial connection system, comprising a male connector of a plug type and a female connector of a jack type according to claim 5.
